(19) United States
(12) Patent Application Publication
(10) Pub. No.: US 2004/0205261 A1
(43) Pub. Date: Oct. 14, 2004

(54) Image forming apparatus and control method therefor, program for executing the control method and storage medium storing the program

(76) Inventor: Mamoru Osada, Kanagawa (JP)

Correspondence Address: ROSSI & ASSOCIATES, P.O. BOX 826, ASHBURN, VA, 20146-0826, US

(21) Appl. No.: 10/753,062

(22) Filed: Jan. 7, 2004

(30) Foreign Application Priority Data
Jan. 7, 2003 (JP) 2003-001309(PAT.

(51) Int. Cl. G06F 9/44

(52) U.S. Cl. 710/8; 717/172

(57) ABSTRACT

In the image forming apparatus, a license management module acquires license information including a apparatus identification information specifying the apparatus and a program specifying information for specifying a program as a program to be executed at the start of the apparatus, from an external device. When the module determines that the program specified by program specifying information has not been set to a program to be executed at the start of the apparatus, it sets the program to a program to be executed.

### BACKGROUND OF THE INVENTION

1. Field of the Invention

The present invention relates to an image forming apparatus having a program installed thereon and a control method therefor, a program for executing the control method, and a storage medium storing the program.

2. Description of the Related Art

Conventionally, an image forming apparatus, such as an LBP (Laser Beam Printer) or a multi-function machine, can provide various functions, and therefore, it is a general practice to form the image forming apparatus into different types, functions of which are different from one type to another e.g. according to the price, and provide the thus formed different types as different commodity products.

However, in the case of developing image forming apparatuses as commodity products in a line-up similar to so-called sister apparatuses, only a single program is developed as a basic program for controlling the apparatuses, a plurality of program modules for realizing respective functions to be provided by the apparatuses are prepared, and then program modules corresponding to the product specification of each apparatus are enabled, whereby functions corresponding to the commodity product line-up are provided (Japanese Laid-Open Patent Publication (Kokai) 2001-092779).

Further, in some of the above-mentioned sister apparatuses, an option is available for a little-sister apparatus, which allows the little-sister apparatus to meet the same specification as that for a big-sister apparatus. The little-sister apparatus is constructed such that a user who owns the apparatus can buy the option later and use a new function realized by the option. In this case, when the option is a hardware one, it is possible to enable a program module corresponding to the option automatically by a mechanical or electrical identification device.

On the other hand, when the option is a software one, it may be necessary to explicitly enable a program module corresponding to the option by an external device. The enabling of this program module can be performed by a method in which a service person connects a dedicated device for rewriting program identification information stored in a start program identification device to the image forming apparatus to thereby rewrite the information, or by another method in which a password corresponding to the program module is entered via the operating section of the image forming apparatus, or a PC (Personal Computer), which is connected to the image forming apparatus.

Once the program module is enabled, it permanently stays enabled.

However, in the case of using the dedicated rewriting device for enabling a program module as described above, extra costs are incurred, including manufacturing costs of the device itself, and costs for sending a service person to a location where the apparatus is installed.

On the other hand, when the method of entering a password corresponding to a program module to be enabled is employed, if the password is accidentally leaked, a user not to be authorized becomes capable of using the function illegally, and therefore adequate security is not ensured.

Further, in the above enabling method, a single rewriting device or a password is used for one type of products, but rewriting cannot be executed on an individual product-by-individual product basis. Therefore, the method is not capable of ensuring countermeasures against illegal use of the rewriting device and leakage of the password. In addition, once a program module is enabled, it can be used permanently, and therefore, there is a fear of the program module being used illegally over a long term.

### SUMMARY OF THE INVENTION

It is one of the aspects of the present invention to provide an image forming apparatus and a control method therefor, and a program for executing the control method, which are capable of enabling programs that realize optional functions, without extra costs, as well as enhancing security for the enabling of the optional functions, and a storage medium storing the program.

To achieve the above aspect in the present invention, there is provided an image forming apparatus comprising a storage device that stores apparatus identification information for identifying the image forming apparatus, and a plurality of programs for realizing optional functions, respectively, a program management device that holds start program identification information indicative of whether each of the plurality of programs has been set to a program to be executed at a start of the image forming apparatus, in association with each of the plurality of programs, and a license management device that permits use of the plurality of programs on a program-by-program basis, and the license management device comprises a license information acquisition device that acquires license information including apparatus specifying information and program specifying information for specifying a program designated from an external device as a program to be executed at the start of the image forming apparatus, a determination device that determines, by referring to the start program identification information held by the program management device, whether the program identified by the program identification information has been set to a program to be executed at the start of the image forming apparatus, when the apparatus specifying information included in the license information acquired by the license information acquisition device and the apparatus identification information stored in the storage device match, and the program specified by the program specifying information included in the license information is identical to any of the plurality of programs, and a setting device that sets the program specified by the program specifying information to a program to be executed at the start of the image forming apparatus, when the determination device determines that the program specified by the program specifying information has not been set to a program to be executed at the start of the image forming apparatus.

With the arrangement of the first aspect of the present invention, it is possible to enable the programs that realize optional functions, without extra costs, as well as to enhance security for the enabling of the optional functions.

Preferably, the image forming apparatus further comprises an input device via which information can be inputted by operation of an operator, and an external storage device that holds the license information, and the license information acquisition device is responsive to input of predetermined instruction information via the input device by the operation of the operator, for reading and acquiring the license information from the external storage device.

Preferably, the image forming apparatus further comprises a communication device that communicates with an external device having a function of inputting the license information by operation of an operator, and a function of transmitting the license information inputted by the operation of the operator, and the license information acquisition device receives and acquires the license information transmitted from the external device, via the communication device.

Preferably, the image forming apparatus further comprises a communication device that communicates with an external device capable of holding the license information, and an inquiry device that periodically inquires of the external device via the communication device whether the license information is held in the external device, and the license information acquisition device is responsive to a notification that the license information is held in the external device, given by the external device in response to the inquiry, for acquiring the license information from the external device via the communication device.

With the arrangements of these preferred embodiments, it is possible to enable the optional functions without a service person's in-field service at a site where the image forming apparatus is installed, which contributes to further reduction of costs.

Preferably, the image forming apparatus further comprises a clock device that outputs time information, and the license information includes an expiration date of the program specified thereby, the license management device comprising a license information holding device that holds the license information associated with each of programs set to a program to be executed at the start of the image forming apparatus an expiration date determining device that compares the expiration date included in the license information associated with each of the programs set to a program to be executed at the start of the image forming apparatus with the time information outputted from the clock device, to thereby determine whether the expiration date has passed and a limiting device that limits execution of each of the programs set to a program to be executed at the start of the image forming apparatus, based on a result of the determination by the expiration date determining device.

With the arrangement of this preferred embodiment, the expiration date is set in the license information, and therefore it is possible to prevent long-term illegal use of the optional functions.

Preferably, the image forming apparatus further comprises a totalizing device that totalizes amounts of usage of apparatus resources used by operation of the programs on a program-by-program basis, and the license information includes an upper limit of an amount of usage of resources usable by each program specified by the license information, the license management device comprising a license information holding device that holds the license information associated with each of programs set to a program to be executed at the start of the image forming apparatus, a usage determining device that determines whether the amount of usage of the apparatus resources used by each of the programs set to a program to be executed at the start of the image forming apparatus has reached the upper limit thereof, and a limiting device that limits execution of each of the programs set to a program to be executed at the start of the image forming apparatus, based on a result of the determination by the usage determining device.

With the arrangement of this preferred embodiment, the usage limit is set in the license information, and therefore it is possible to prevent illegal use of the optional functions.

Preferably, the license information comprises encrypted information, and the license management device comprises a decrypting device that decrypts the license information.

With the arrangement of this preferred embodiment, the license information is encrypted, and therefore it is possible to prevent illegal use of the optional functions.

To achieve the above object, in a second aspect of the present invention, there is provided a method of controlling an image forming apparatus including a storage device that stores apparatus identification information for identifying the image forming apparatus, and a plurality of programs for realizing optional functions, respectively, and a program management device that holds start program identification information indicative of whether each of the plurality of programs has been set to a program to be executed at a start of the image forming apparatus, in association with each of the plurality of programs, the method comprising a license information acquisition step of acquiring license information including apparatus specifying information and program specifying information for specifying a program designated from an external device as a program to be executed at the start of the image forming apparatus, a determination step of determining, by referring to the start program identification information held by the program management device, whether the program identified by the program identification information has been set to a program to be executed at the start of the image forming apparatus, when the apparatus specifying information included in the license information acquired in the license information acquisition step and the apparatus identification information stored in the storage device match, and the program specified by the program specifying information included in the license information is identical to any of the plurality of programs, and a setting step of setting the program specified by the program specifying information to a program to be executed at the start of the image forming apparatus, when it is determined in the determination step that the program specified by the program specifying information has not been set to a program to be executed at the start of the image forming apparatus.

To achieve the above object, in a third aspect of the present invention, there is provided a program for controlling an image forming apparatus including a storage device that stores apparatus identification information for identifying the image forming apparatus, and a plurality of programs for realizing optional functions, respectively, and a program management device that holds start program identification information indicative of whether each of the plurality of programs has been set to a program to be executed at a start of the image forming apparatus, in association with each of the plurality of programs, the program comprising a license information acquisition module for acquiring license information including apparatus specifying information and program specifying information for specifying a program designated from an external device as a program to be executed at the start of the image forming apparatus, a determination module for determining, by referring to the start program identification information held by the program management device, whether the program identified by the program identification information has been set to a program to be executed at the start of the image forming apparatus, when the apparatus specifying information included in the license information acquired by the license information acquisition module and the apparatus identification information stored in the storage device match, and the program specified by the program specifying information included in the license information is identical to any of the plurality of programs, and a setting module for setting the program specified by the program specifying information to a program to be executed at the start of the image forming apparatus, when it is determined by the determination module that the program specified by the program specifying information has not been set to a program to be executed at the start of the image forming apparatus.

To achieve the above object, in a fourth aspect of the present invention, there is provided a computer-readable storage medium storing a program for controlling an image forming apparatus including a storage device that stores apparatus identification information for identifying the image forming apparatus, and a plurality of programs for realizing optional functions, respectively, and a program management device that holds start program identification information indicative of whether each of the plurality of programs has been set to a program to be executed at a start of the image forming apparatus, in association with each of the plurality of programs, the program comprising a license information acquisition module for acquiring license information including apparatus specifying information and program specifying information for specifying a program designated from an external device as a program to be executed at the start of the image forming apparatus, a determination module for determining, by referring to the start program identification information held by the program management device, whether the program identified by the program identification information has been set to a program to be executed at the start of the image forming apparatus, when the apparatus specifying information included in the license information acquired by the license information acquisition module and the apparatus identification information stored in the storage device match, and the program specified by the program specifying information included in the license information is identical to any of the plurality of programs, and a setting module for setting the program specified by the program specifying information to a program to be executed at the start of the image forming apparatus, when it is determined by the determination module that the program specified by the program specifying information has not been set to a program to be executed at the start of the image forming apparatus.

With the arrangements of the second to fourth aspects of the present invention, it is possible to provide the same advantageous effects as obtained from the first aspect of the present invention.

The above and other objects, features, and advantages of the invention will become more apparent from the following detailed description taken in conjunction with the following drawings.

### BRIEF DESCRIPTION OF THE DRAWINGS

FIG. 1 is a block diagram showing the whole arrangement of an image forming apparatus according to a first embodiment of the present invention;

FIG. 2 is a block diagram schematically showing the arrangement of a controller appearing in FIG. 1;

FIG. 3 is a block diagram showing the arrangement of a network system on which the image forming apparatus shown in FIG. 1 operates;

FIG. 4 is a block diagram showing the internal arrangement of a PC appearing in FIG. 3;

FIG. 5 is a block diagram showing the software configuration of the controller appearing in FIG. 1;

FIG. 6 is a diagram showing start program management data managed by a start program identification module;

FIG. 7 is a block diagram showing the software configuration of a license management module appearing in FIG. 5;

FIG. 8 is a diagram showing management information managed by a core section appearing in FIG. 7;

FIG. 9 is a diagram showing an example of identification information for uniquely identifying the image forming apparatus in FIG. 1;

FIG. 10 is a block diagram showing the software configuration of a license information generation module in a PC appearing in FIG. 3;

FIG. 11 is a diagram showing part of the contents of licensing conditions appearing in FIG. 10;

FIG. 12 is a diagram useful in explaining an example of an operation screen displayed in an operating section appearing in FIG. 1;

FIG. 13 is a diagram useful in explaining an example of a screen for instructing the reading of license information, displayed on the image forming apparatus in FIG. 1;

FIGS. 14A and 14B are diagrams showing examples of screens displayed as results of a license information reading process;

FIG. 15 is a flowchart of the license information reading process;

FIG. 16 is a flowchart of a license input process executed in the license information reading process in FIG. 15;

FIG. 17 is a diagram showing an updated start program management data table;

FIG. 18 is a diagram showing updated management information;

FIG. 19 is a diagram showing an example of a used resources totalizing table managed by a used resources totalizing module appearing in FIG. 5;

FIG. 20 is a flowchart of a determination process executed by the license management module appearing in FIG. 5;

FIG. 21 is a flowchart of an expiration date check process executed by the license management module;

FIG. 22 is a flowchart of a used resources check process executed by the license management module;

FIG. 23 is a block diagram showing the configuration of a license management module in an image forming apparatus according to a second embodiment of the present invention;

FIG. 24 is a diagram useful in explaining an example of a web site displayed on a CRT appearing in FIG. 4;

FIG. 25 is a flowchart showing part of a process executed by a core section appearing in FIG. 23; and

FIG. 26 is a block diagram showing the configuration of a license management module in an image forming apparatus according to a third embodiment of the present invention.

### DETAILED DESCRIPTION OF THE PREFERRED EMBODIMENTS

The present invention will now be described in detail with reference to the accompanying drawings showing preferred embodiments thereof.

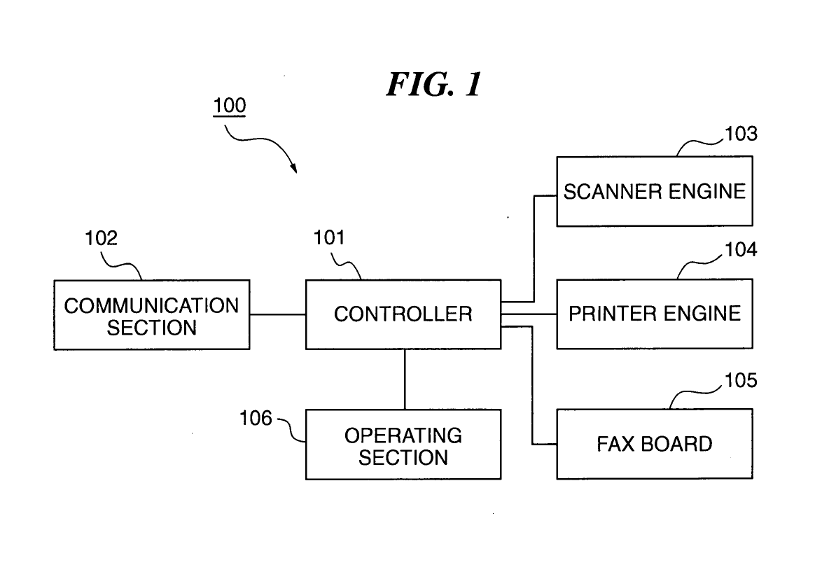

FIG. 1 is a block diagram showing the arrangement of an image forming apparatus according to an embodiment of the present invention.

As shown in FIG. 1, the image forming apparatus 100 (MFP) is comprised of a controller 101 that controls the overall operation of the image forming apparatus 100, a communication section 102, a scanner engine 103, a printer engine 104, a FAX board 105, and an operating section 106. The image forming apparatus 100 forms an MFP (Multi-Function Peripheral) that realizes a plurality of functions of a scanner, a printer, and a facsimile.

The communication section 102 is provided to allow the controller 101 to communicate with external devices (not shown). The communication section 102 may be implemented by an Ethernet, an IEEE 1284 or any other interface that realizes a communication function, and it is not limited to a single interface of these. The scanner engine 103 is controlled by the controller 101. The printer engine 104 is also controlled by the controller 101. The printer engine 104 may be implemented by a laser beam printer, an inkjet printer, or another type of printer. The FAX board 105 is provided to realize facsimile functions, such as communication control in transmission/reception of images, and is also controlled by the controller 101. The operating section 106 includes a display formed e.g. by an LCD (Liquid Crystal Display), referred to hereinafter, and a keyboard. The operating section 106 displays information from the controller 101 as well as transmits user instructions to the controller 101.

The image forming apparatus 100 constructed as above is allowed to issue a scanning job when the scanner engine 103 is selected by the user, and issue a copying job when the printer engine 104 and the scanner engine 103 are selected. Further, when the printer engine 104, the scanner engine 103, and the FAX board 105 are selected, the apparatus 100 is allowed to issue a FAX receiving job, and a FAX transmitting job.

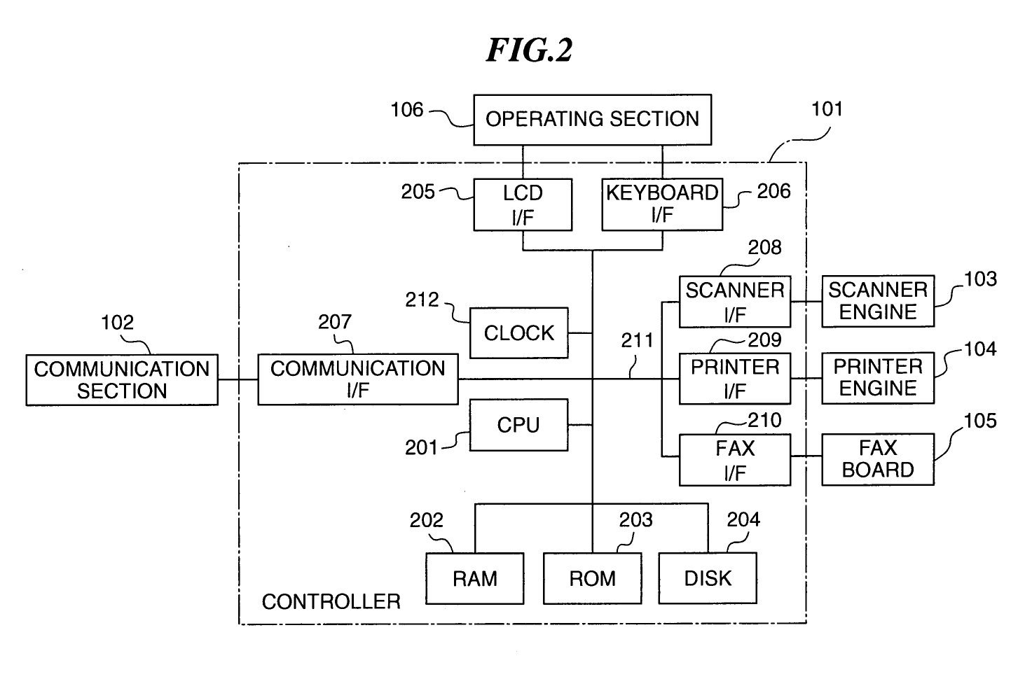

Next, the arrangement of the controller 101 will be described with reference to FIG. 2. FIG. 2 is a block diagram schematically showing the arrangement of the controller 101 in FIG. 1.

As shown in FIG. 2, the controller 101 is comprised of a CPU (Central Processing Unit) 201, a RAM (Random Access Memory) 202, a ROM (Read Only Memory) 203, a DISK (storage device) 204, an LCD interface (I/F) 205, a keyboard I/F 206, a communication I/F 207, a scanner I/F 208, a printer I/F 209, a FAX I/F 210, and a clock 212, all of which are interconnected via the system bus 211. In the present embodiment, the DISK 204 is implemented by a storage device, such as a hard disk device.

A control program that controls the controller 101 is stored in the ROM 203 or the DISK 204, and a necessary module is read out into the RAM 202 by a program management module 501, described in detail hereinafter, and executed by the CPU 201. Further, the ROM 203 and the DISK 204 store not only the control program, but also attribute information indicative of functions and statuses of the image forming apparatus 100 and jobs to be processed by the image forming apparatus 100, and job data to be outputted. Further, the CPU 201 displays information and messages via the operating section 106 and the LCD I/F 205, and receives instructions from the user via the keyboard I/F 206. The CPU 201 also communicates with external devices via the communication I/F 207.

The CPU 201 receives a user instruction from the keyboard I/F 206 via the system bus 211 and executes a job according to the user instruction while controlling the RAM 202, the ROM 203, the DISK 204, the LCD I/F 205, the communication I/F 207, the scanner engine I/F 208, the printer engine I/F 209 and the FAX board I/F 210.

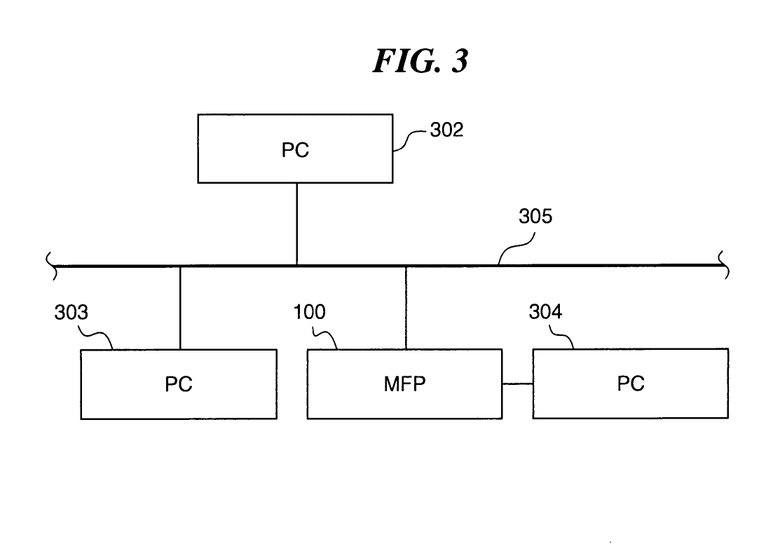

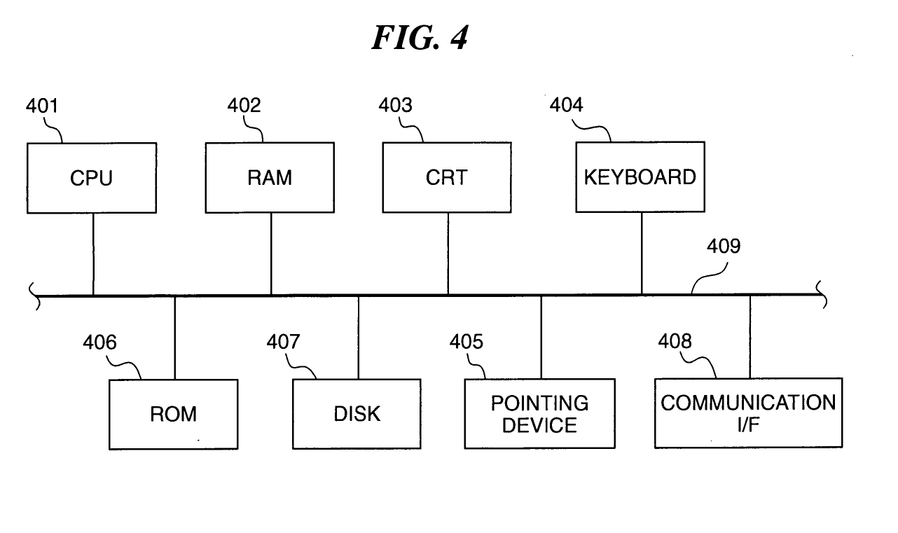

Next, a network system on which the image forming apparatus 100 operates will be described with reference to FIGS. 3 and 4. FIG. 3 is a block diagram showing an example of the arrangement of the network system on which the image forming apparatus in FIG. 1 operates, and FIG. 4 is a block diagram showing the internal arrangement of a PC appearing in FIG. 3.

As shown in FIG. 3, the image forming apparatus 100 is connected to the network 305 accommodating a plurality of PC's (Personal Computers) 302 and 303, as well as to the PC 304. Via the network 305, the image forming apparatus 100 may be also connected to workstations, other image forming apparatuses, and other apparatuses and devices.

As shown in FIG. 4, each of the PC's 302, 303 and 304 is comprised of a CPU 401, a RAM 402, a CRT (Cathode Ray Tube) 403, a keyboard 404, a pointing device 405, a ROM 406, a DISK (hard disk device) 407 and a communication I/F 408, all of which are interconnected via a system bus 409.

A program that controls the PC is stored in the ROM 406 or the DISK 407. The program is read out into the RAM 402, as required, and executed by the CPU 401. Further, the CPU 401 displays information and images on the CRT 403, and receives instructions from the user via the keyboard 404 and the pointing device 405. The CPU 401 also communicates with external devices via the communication I/F 408.

The CPU 401 receives a user instruction from the keyboard 404 or the pointing device 405 via the system bus 409 and executes a process according to the user instruction while controlling the RAM 402, the CRT 403, the ROM 406, the DISK 407, and the communication I/F 408.

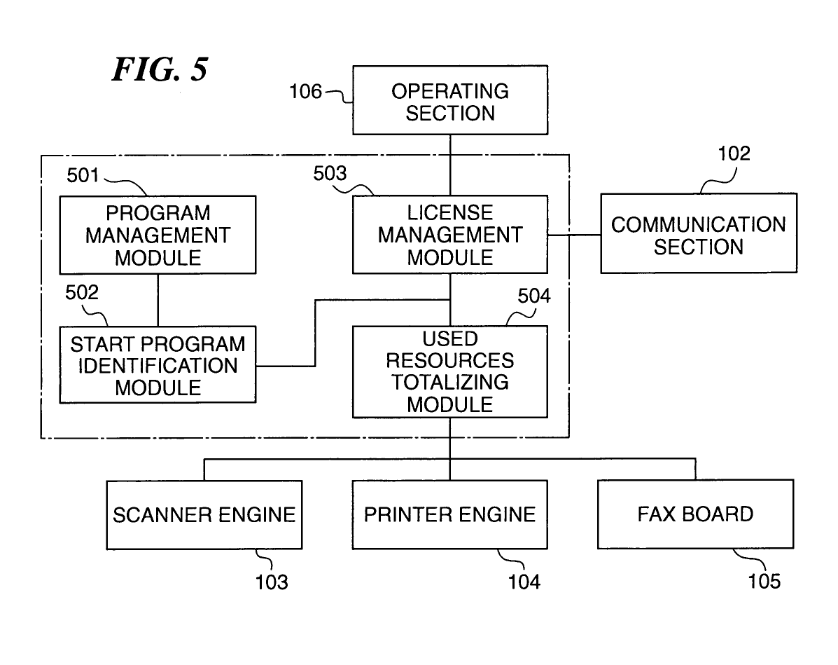

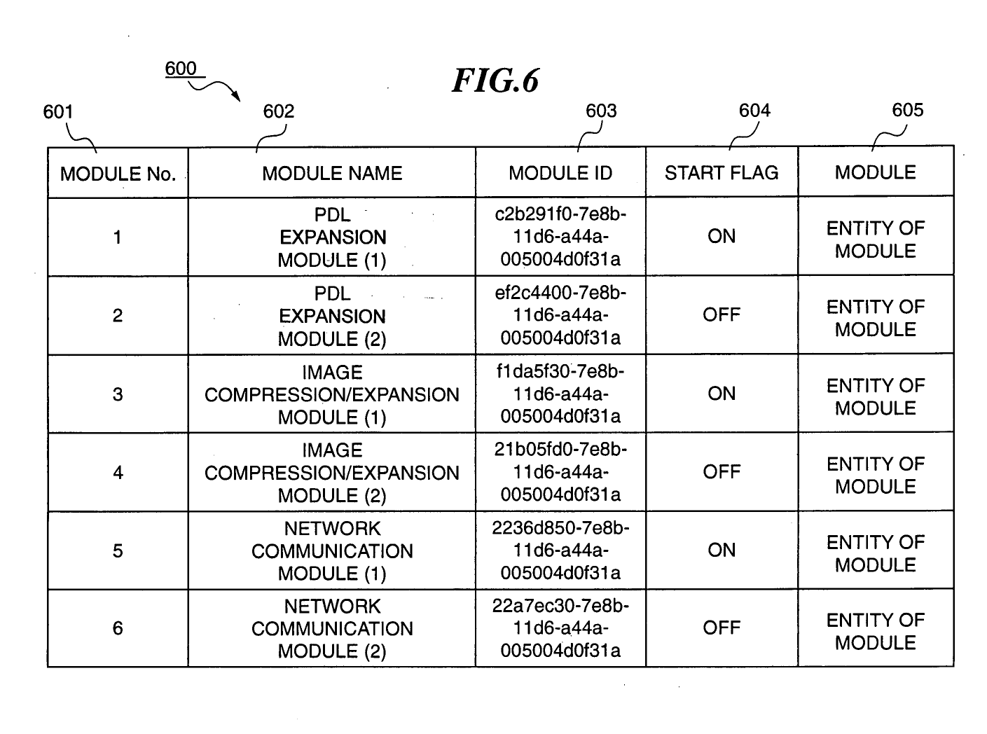

Next, the main part of software of the controller 101 of the image forming apparatus 100 will be described in detail with reference to FIGS. 5 and 6. FIG. 5 is a block diagram showing the main part of the software of the controller 101, and FIG. 6 is a diagram showing a start program management data 600 managed by a start program identification module 502.

As shown in FIG. 5, the main part of the software of the controller 101 includes a program management module 501, the start program identification module 502, a license management module 503, and a used resources totalizing module 504. The program management module 501 is comprised of programs to be executed by the CPU 201 immediately after the controller 101 is started. The program management module 501 sequentially starts program modules to be started according to information stored in the start program identification module 502. The start program identification module 502 manages the information of the program modules to be started. The license management module 503 communicates with the operating section 106 or the communication section 102, and executes predetermined processes. The used resources totalizing module 504 totalizes resources used by the scanner engine 103, the printer engine 104, and the FAX board 105, on a program module-by-program module basis.

The start program identification module 502 stores a start program management data table 600 shown in FIG. 6. The start program management data table 600 is provided with records for a module number 601, a module name 602, a module ID 603, a start flag 604, and a module 605. The start program management data table 600 manages each program module based on descriptive information of records associated with the program module.

The fields of the module number 601 store numbers sequentially assigned to the respective program modules managed as record start program management data. The fields of the module name 602 store the names of the program modules. The fields of the module ID 603 store ID's for uniquely identifying the program modules, and UUID's (Universal Unique ID's) are used as the ID's. The fields of the start flag 604 store information for determining whether or not the program modules should be started. The fields of the module 605 store reference destinations of the entities of the program modules (e.g. PDL expansion modules (1)). A program module at a reference destination is executed by the program management module 501 according to information stored in the associated field of the start flag 604.

It should be noted that although in the present embodiment, the table is used as management means for managing program modules to be started, this is not limitative, but any other method which is capable of identifying a related program module and determining whether or not the program module should be started can be employed. Further, although the UUID is used to uniquely identify a program module, this is not limitative, either.

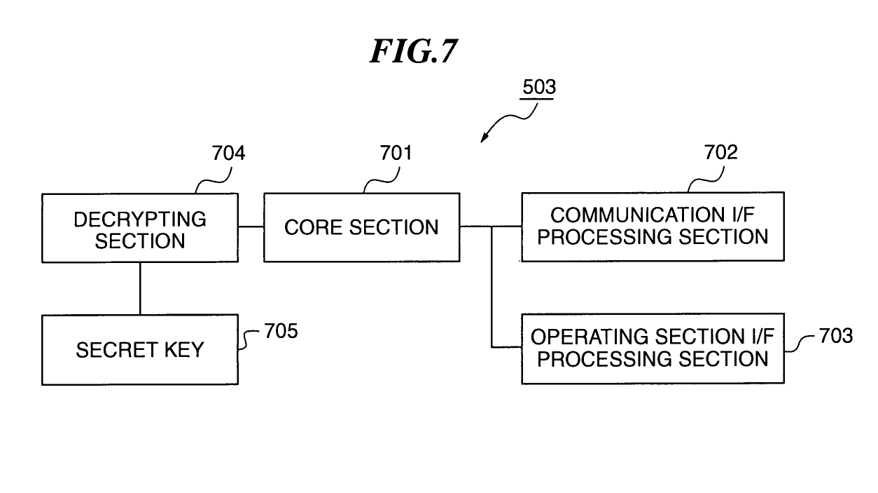

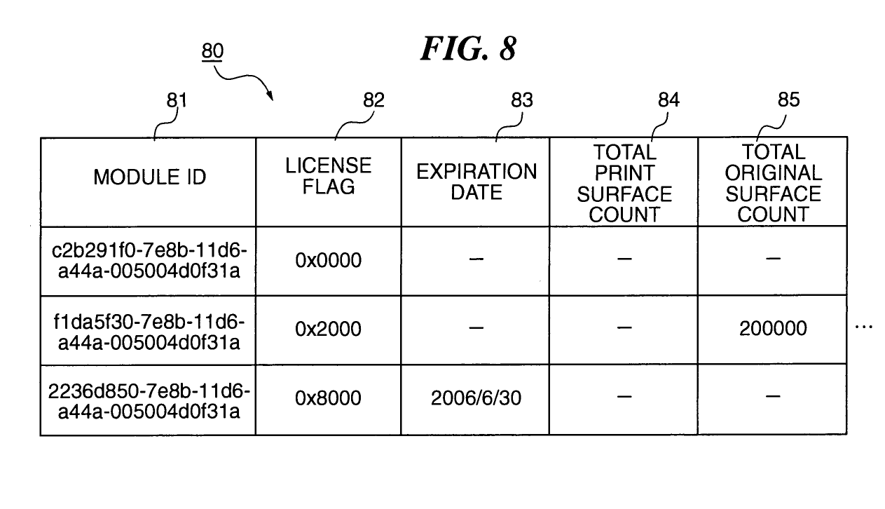

Next, the configuration of the license management module 503 will be described with reference to FIGS. 7 and 8. FIG. 7 is a software block diagram showing the configuration of the license management module 503 shown in FIG. 5, and FIG. 8 is a diagram showing management information 80 managed by a core section 701 of the license management module 503 appearing in FIG. 7.

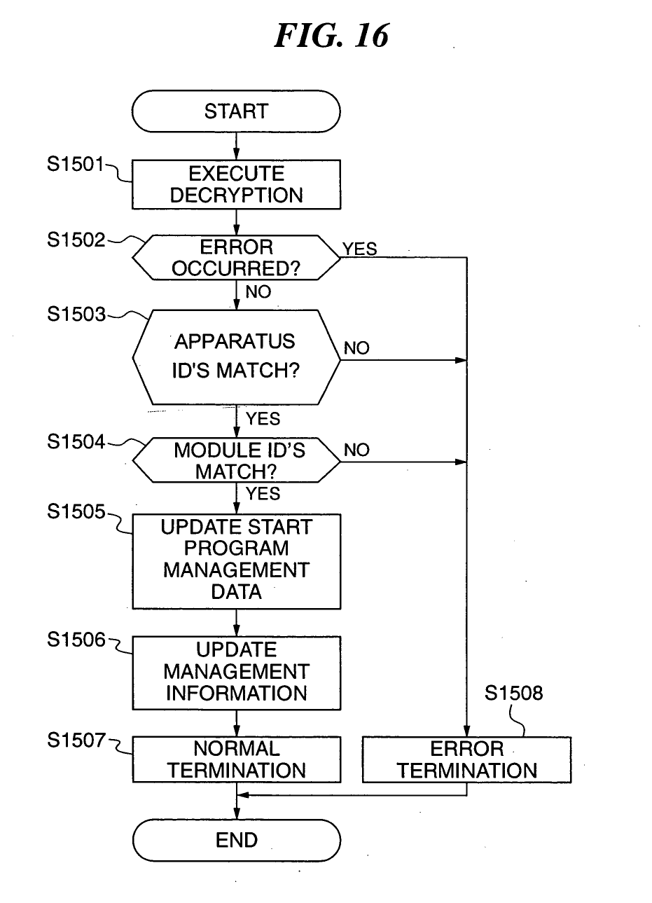

As shown in FIG. 7, the license management module 503 includes the core section 701, a communication I/F processing section 702, an operating section I/F processing section 703, a decrypting section 704, and a secret key 705. The core section 701 executes a process based on a flowchart shown in FIG. 16, described in detail hereinafter. The communication I/F processing section 702 communicates with the communication section 102. The operating section I/F processing section 703 communicates with the operating section 106. The decrypting section 704 executes a decoding process for decrypting license information 905, described in detail hereinafter. The secret key 705 is secret key information to be used by the decrypting section 704 for decryption.

It should be noted that in the present embodiment, a public key and a secret key are used for encrypting and decrypting license information, but this is not limitative.

The core section 701 of the license management module 503 manages the management information 80 as shown in FIG. 8. The management information 80 is comprised of a module ID 81, a license flag 82, an expiration date 83, a total print surface count 84, and a total original surface count 85.

The module ID 81 is information for identifying a program module, which is the same information stored in the module ID 603. The license flag 82 is identification information for identifying license information given to the module ID 81. Each bit of data of the identification information indicates which type of license, referred to hereinafter, is allowed to use. When no bit of the data is in the ON state, it is indicated that there exists no license given to the associated module ID 81. For example, the expiration date 83 corresponds to the most significant bit (0×8000), and the total print surface count 84 corresponds to the second significant bit (0×4000). It should be noted that the method of setting the identification information is not limited to the above described method.

The expiration date 83 is license information indicative of an expiration date on which the permission of use of a program module expires. In the present embodiment, an absolute date (year/month/day) is used as an expiration date. However, it is also possible to use a valid term indicative of the number of days over which a module is usable. The total print surface count 84 is license information indicative of the total number of print surfaces that can be used. The total original surface count 85 is license information indicative of the total number of original surfaces that can be used.

It should be noted that usable resources are not limited to those exemplified in the present embodiment, but the number of bytes transmitted onto the network 305 may be used as resources, for example.

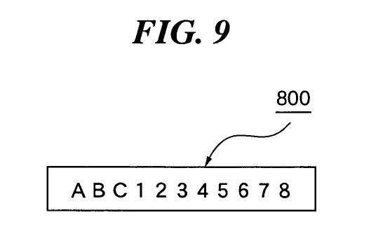

Next, identification information stored in the RAM 202, the ROM 203 or the DISK 204 of the controller 101, for uniquely identifying the image forming apparatus in FIG. 1 will be described with reference to FIG. 9. FIG. 9 is a diagram showing an example of the identification information for uniquely identifying the image forming apparatus in FIG. 1.

In the present embodiment, the RAM 202, the ROM 203 or the DISK 204 of the controller 101 stores the apparatus identification information 800, shown in FIG. 9, for uniquely identifying the image forming apparatus 100, and a serial number is used as the apparatus identification information 800. However, the apparatus identification information 800 is not limited to a serial number, but any other form of ID, such as UUID, which can be used for unique identification of the image forming apparatus 100 may be employed.

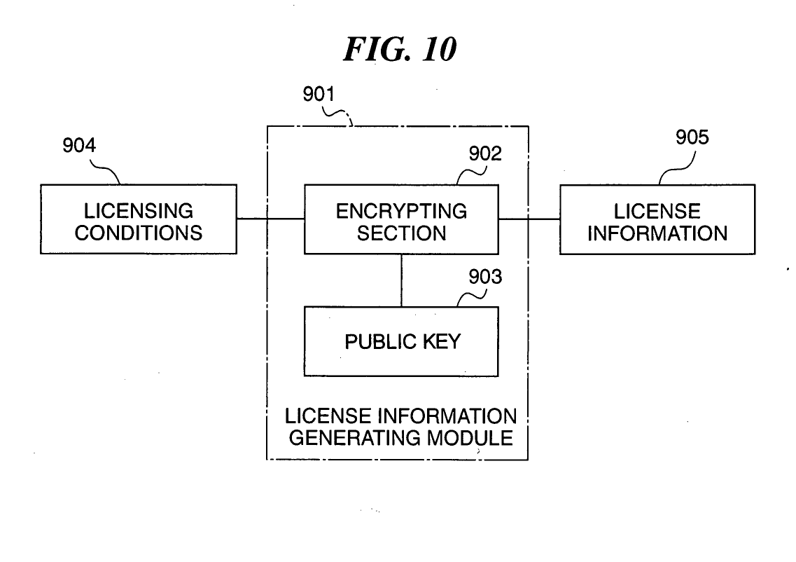

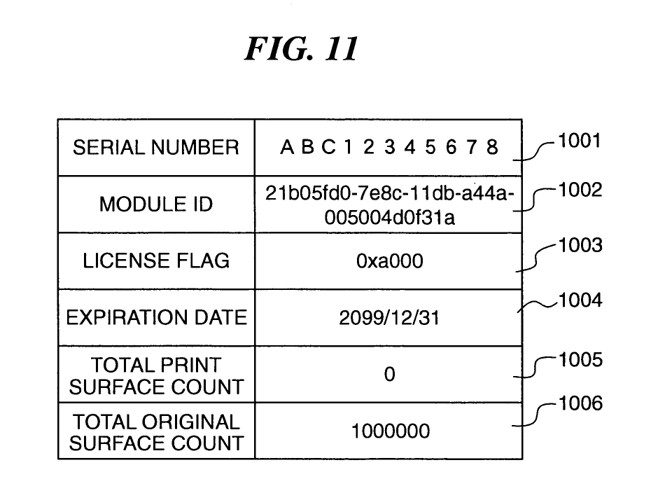

Next, a tool provided in each of the PC's 302, 303 and 304, for generating the license information will be described with reference to FIGS. 10 and 11. FIG. 10 is a block diagram showing the software configuration of a license information generating module in each of the PC's 302, 303 and 304 appearing in FIG. 3, and FIG. 11 is a diagram showing part of the contents of licensing conditions appearing in FIG. 10.

As shown in FIG. 10, each of the PC's 302, 303 and 304 includes the license information generating module 901, and the license information generating module 901 is comprised of an encrypting section 902 and a public key 903.

The encrypting section 902 encrypts entered licensing conditions 904 using the public key 903 to generate license information 905, and outputs the license information 905. The public key 903 forms a pair with the aforementioned secret key 705. The licensing conditions 904 includes information necessary for generation of the license information. The license information 905 is passed to the license management module 503 of the image forming apparatus 100, as information for controlling the start of a predetermined program module.

For example, one set of licensing conditions 904 is comprised of a plurality of data items 1001 to 1006 and contents corresponding to the respective data items, as shown in FIG. 11. The licensing conditions 904 may be formed of text data or binary data, but should not be considered to be limitatively defined by a specific data format.

The data item 1001 stores the serial number. The serial number is information for uniquely specifying the image forming apparatus 100, and is the same information as the apparatus identification information 800 held by the image forming apparatus 100. The data item 1002 stores the same module ID as the module ID 603 described hereinabove. In the illustrated example, the module ID of a FAX scan module is stored.

The data item 1003 stores identification information as a license flag, for identifying license information given to the module ID stored in the data item 1002, and the identification information has data each bit of which indicates which type of license, described in detail hereinafter, is allowed to use. When no bit of the data is in the ON state, it is indicated that there exists no license. Further, an expiration date stored in the data item 1004 corresponds to the most significant bit (0×8000) of the license flag, and the total print surface count stored in the data item 1004 corresponds to the second significant bit (0×4000) of the same. It should be noted that the method of holding the identification information is not particularly limited to that in the present embodiment.

The data item 1004 stores the expiration date of the program module specified in the data item 1002. The data item 1005 stores license information of a total print surface count representative of the total number of usable print surfaces. In the present example, this license field is not referred to, because of the license flag stored in the data item 1003.

The data item 1006 stores license information of a total original surface count. In the example illustrated in FIG. 11, it is possible to use 1,000,000 original surfaces (sheet surfaces of originals) at the maximum. It should be noted that usable resources are not limited to those in the present embodiment, but the number of bytes of data sent onto the network may be used.

In the present embodiment, it is assumed that the license information 905 has been generated in advance and stored in a predetermined area of the DISK 407 of the PC 302.

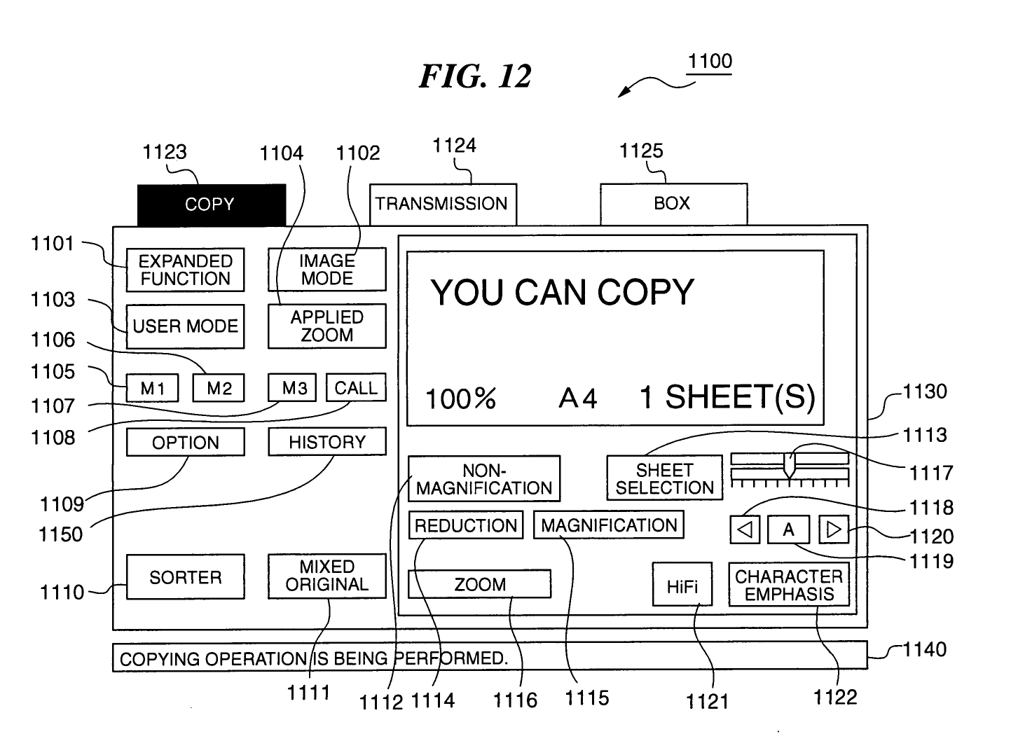

Next, an operation screen displayed on the operating section 106 of the image forming apparatus 100 will be described with reference to FIG. 12. FIG. 12 is a diagram showing an example of the operation screen.

The operating section 106 includes the display implemented e.g. by an LCD (liquid crystal display) and the keyboard as described hereinabove. The display has a screen on which a touch panel is attached, and when an area within a frame for each function displayed on the screen is touched, the function is performed.

On the display of the operating section 106, the operation screen 1100 illustrated in FIG. 12 is displayed, for example. When a copy mode key 1123 is selected from function selection keys (copy mode key 1123, transmission mode key 1124, and box mode key 1125) and depressed on the operation screen 1100, a copy mode screen 1130 is displayed. On the copy mode screen 1130, various soft keys for use in selecting and operating respective functions related to the copy mode are displayed. The transmission mode key 1124 is depressed for carrying out facsimile transmission or the like. The box mode key 1125 is depressed for handling data stored in a box.

On the screen 1130 are displayed an expanded function selection key 1101, an image mode key 1102, a user mode key 1103, an applied zoom key 1104, an M1 key 1105, an M2 key 1106, an M3 key 1107, an option key 1109, a sorter key 1110, a mixed original key 1111, a non-magnification key 1112, a sheet selection key 1113, a reduction key 1114, a magnification key 1115, density keys 1118 and 1120, an AE key 1119, a HiFi key 1121, a character emphasis key 1122, a history key 1150, and so forth.

The expanded function selection key 1101 is for selecting a double-sided copying mode, a multi-copying mode, a transfer mode, a binding margin setting mode, or a frame cancellation setting mode. The image mode key 1102 is for setting a mode for hatching, shading, trimming, or masking a copied image. The,user mode key 1103 is for registering a mode memory and configuring a standard mode screen. The applied zoom key 1104 is for selecting a mode for scaling an image in the X and Y directions of an original, independently of each other, or a zoom program mode for calculating a scaling factor based on an original size and a copy size.

Each of the M1 key 1105, the M2 key 1106, and the M3 key 1107 is depressed for calling a mode memory registered for the key. The option key 1109 is for setting an optional function e.g. of a film projector, for copying an image directly from a film. The sorter key 1110 is for setting a sort mode, a non-sort mode, or a group mode. The mixed original key 1111 is depressed for setting originals of the A4 size and the A3 size, or originals of the B5 size and the B4 size together on an original feeder. The non-magnification key 1112 is depressed for setting the copying size ratio to 100%. The sheet selection key 1113 is depressed for selecting a copy sheet. The reduction key 1114 and the magnification key 1115 are depressed for scaling up or down a standardized size.

The density keys 1118 and 1120 are for use in setting copying density, and configured such that the copying density is increased whenever the key 1118 is depressed, and decreased whenever the key 1120 is depressed. Each time the density key 1118 or 1120 is depressed, a density indicator 1117 moves leftward or rightward to indicate the set density level. The AE key 1119 is depressed for copying an original, such as newspaper, with a dark background, while automatically adjusting the copying density thereof. The HiFi key 1121 is depressed for copying an original, such as a photograph, with a high half-tone density. The character emphasis key 1122 is depressed for highlighting characters in copying a text original. The history key 1150 is depressed for displaying historical information of completed print jobs. The historical information includes the time of completion, user name, file name, and printed sheet count of each print job.

Further, a status line 1140 is displayed which shows a message indicative of a status of the devices and print information. In the illustrated example, it is indicated that copying operation is being performed.

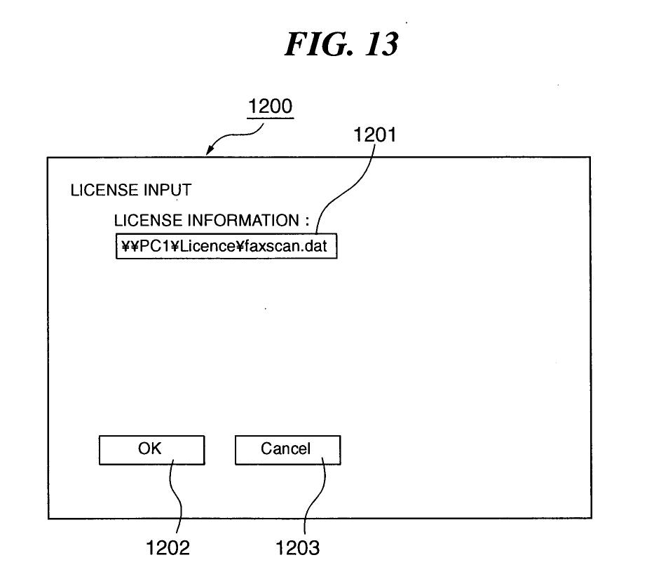

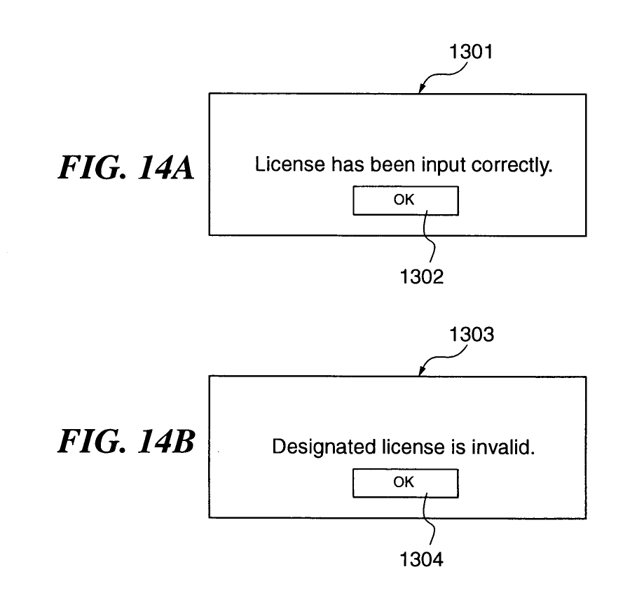

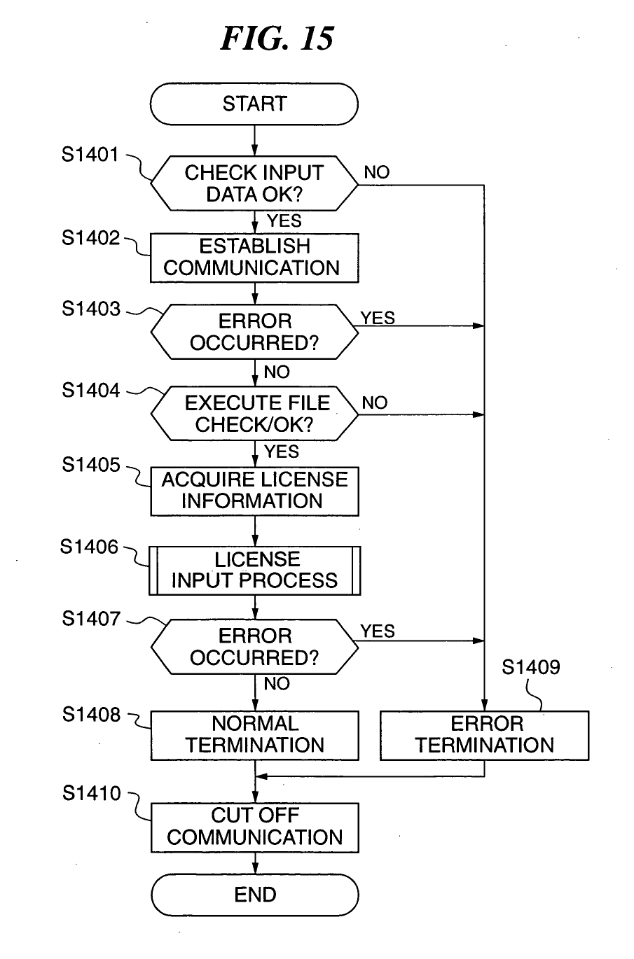

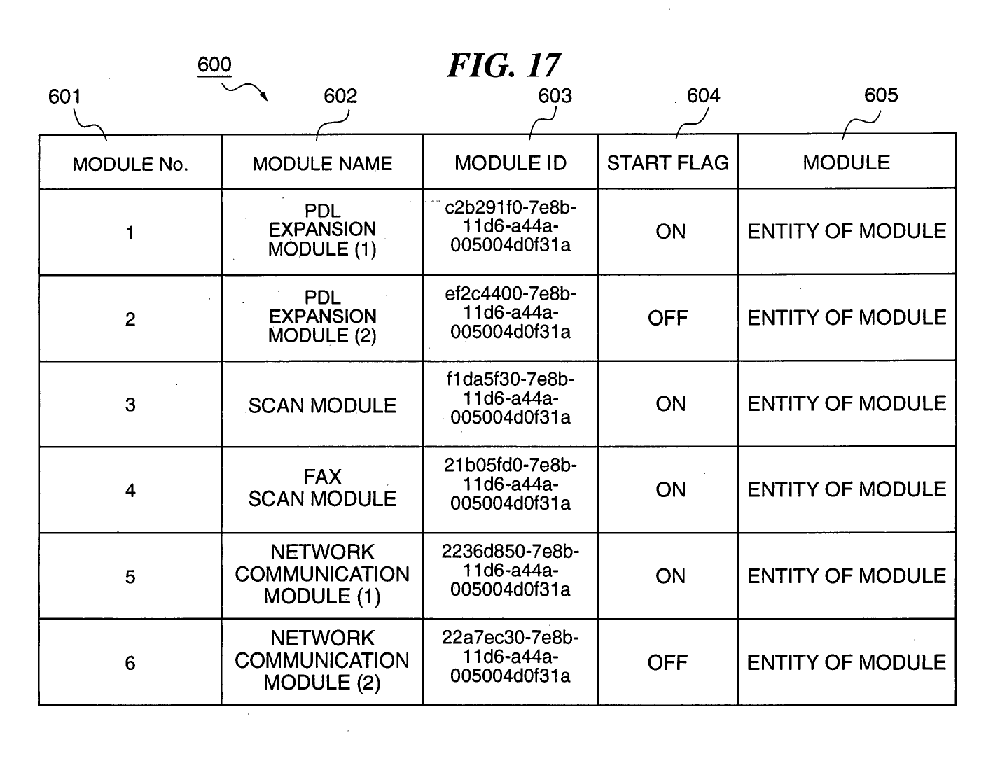

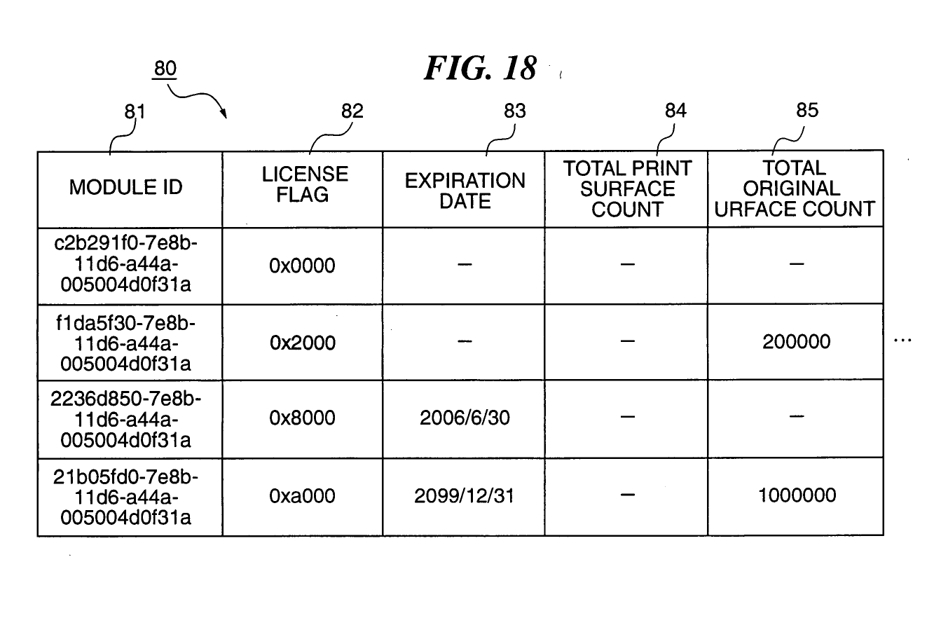

Next, a license information reading process executed on the image forming apparatus 100 will be described with reference to FIGS. 13 to 17. FIG. 13 is a diagram useful in explaining an example of a screen for giving an instruction for reading the license information, displayed on the image forming apparatus in FIG. 1; FIGS. 14A and 14B are diagrams showing examples of screens displayed as results of the license information reading process; FIG. 15 is a flowchart of the license information reading process; FIG. 16 is a flowchart of a license input process executed in a step S1406 appearing in FIG. 15; FIG. 17 is a diagram showing an updated start program management data table; and FIG. 18 is a diagram showing updated management information.

To read the license information using the image forming apparatus 100, a numeric keypad of the operating section 106 is operated by an operator, such as a service person, on the screen illustrated in FIG. 12. As a result, the screen is switched to a screen 1200 shown in FIG. 13. In the present embodiment, it is assumed that a program that controls this screen operates on the license management module 503.

As shown in FIG. 13, on the screen 1200 are displayed an input field 1201 for designating data of license information, an “OK” button 1202 for giving an instruction for reading the license information, and a “Cancel” button 1203 for giving an instruction for stopping the process on the present screen and returning to a predetermined screen. Now, let it be assumed that predetermined data stored in the DISK 407 in the PC 302 on the network 305 is designated in the field 1201. After the predetermined data has been thus designated, when the “OK” button is depressed, the license information reading process represented by the flowchart shown in FIG. 15, described in detail hereinafter, is executed, whereas when the “Cancel” button is depressed, the screen returns to the copy mode screen 1130.

The method of designating data of license information is not limited to the above described one. For example, a method may be employed in which the PC 302, the PC 303, and the PC 304 on the network 305 are visually arranged and the contents of the DISK 407 in the respective PC's are visually displayed for selection of license information. Further, although in the present embodiment, the PC 302 on the network 305 is used as a storage destination of the license information, the license information may be stored in the PC 304 connected locally to the image forming apparatus 100 or in a removable storage device, not shown.

When the “OK” button 1202 is depressed on the screen 1200, the license information reading process in FIG. 15 is executed, and the screen 1301 shown in FIG. 14A or the screen 1303 shown in FIG. 14B is displayed according to the result of the process. The screen 1301 is a normal termination screen displayed when the license information reading process in FIG. 15 is successfully executed. On this screen are displayed a message “The license has been entered correctly.” and a button 1302 for closing the screen 1301. When the button 1302 is depressed, the screen is switched to the screen shown in FIG. 13. The screen 1303 is an error termination screen displayed when the process ends in failure, and on the screen are displayed a message “The designated license is invalid.” and a button 1304 for closing the screen 1303. When the button 1304 is depressed, the screen is switched to the screen shown in FIG. 12.

Next, a description will be given of the license information reading process started when the “OK” button 1202 is depressed on the screen 1200.

In the present process, as shown in FIG. 15, first in a step S1401, the data name designated in the input field 1201 is checked so as to determine whether or not the designated data is correct. If the designated data is correct, a process for establishing communication with the storage destination of the data of the license information entered in the input field 1201 is executed in a step S1402. In this step, the communication section 102 operates to connect the image forming apparatus 100 to the communication I/F 408 of a PC, which corresponds to the storage destination of the data of the license information, via the network 305. Then, it is determined in a step S1403, whether or not an error has occurred in establishing the communication in the step S1402. If no error has occurred, i.e. if the communication has been successfully established, it is determined in a step S1404 whether or not the data of the license information designated in the input field 1201 exists. If the designated data of the license information exists, the process proceeds to a step S1405.

In the step S1405, the license information is read from the entered location where the license information (more specifically, the data thereof) exists. In the present example, the license information stored in the DISK 407 of the PC 302 is read out and then stored in the RAM 202 or the DISK 204 of the image forming apparatus 100. Then, in a step S1406, the license input process is executed for actually reflecting the license information stored in the RAM 202 or the DISK 204 in the step S1405 on the image forming apparatus 100. The license input process is executed by the license management module 503. The license input process by the license management module 503 will be described in detail hereinafter with reference to FIG. 16.

Then, it is determined in a step S1407 whether or not the license input process has been normally terminated in the step S1406. If the license input process has been normally terminated, the normal termination screen 1301 is displayed in a step S1408. When the button 1302 is depressed on the normal termination screen 1301, the present step is terminated, and in a step S1410, the communication established in the step S1402 is cut off. If it is determined in the step S1407 that the license input process has not been normally terminated, the error termination screen 1303 is displayed in a step S1409. Then, when the button 1304 is depressed on the error termination screen 1303, the present step is terminated, followed by cutting off the communication in the step S1410.

If it is determined in the step S1401 that the designated data is not correct, if it is determined in the step S1403 that an error has occurred in establishing the communication, or if it is determined in the step S1404 that the designated data of the license information does not exist, the error termination process is carried out in the step S1409, followed by cutting off the communication in the step S1410.

Now, the license input process executed in the step S1406 will be described in detail with reference to FIG. 16. This process is executed by the core section 701 of the license management module 503.

As shown in FIG. 16, in the license input process, decryption is carried out in a step S1501. In this step, the license information 905 acquired in the step S1405 is decrypted using the secret key 705 in the decrypting section 704, whereby the licensing conditions 904 are acquired. Then, it is determined in a step S1502 whether or not the decryption has been successfully performed. If the decryption has been successfully performed, the apparatus identification information 800 and the apparatus identification information included in the licensing conditions 904, i.e. the serial number 1001, are compared with each other so as to determine whether or not the two match.

If it is determined in the step S1503 that the apparatus identification information 800 and the serial number 1001 in the licensing conditions 904 match, each module ID in the start program management data table 600 held by the start program identification module 502 and the module ID 1002 of the licensing conditions 904 are compared with each other in a step S1504, and it is determined, based on the result of the comparison, whether or not the start program management data table 600 contains any module ID that matches the module ID 1002.

If it is determined in the step S1504 that there exists a module ID that matches the module ID 1002, the data of the start program management data table 600 in the start program identification module 502 is updated in a step S1505. In the present embodiment, as shown in FIG. 17, the data of the start program management data table 600 is modified such that a program associated with a module ID matching the module ID 1002 of the licensing conditions 904, i.e. the FAX scan module of the module No. 4 is to be started.

Then, the management information 80 managed by the license management module 503 is updated in a step S1506. As shown in FIG. 18, if any data having a module ID that matches the module ID 1002 exists, its record is updated, and if there is no data having a module ID that matches the module ID 1002, a new record is added. Then, a status indicative of normal termination of the present process is set in a step S1507.

If it is determined in the step S1502 that the decryption has ended in failure, if it is determined in the step S1503 that the apparatus identification information 800 and the module ID 1002 of the licensing conditions 904 do not match, or if it is determined in the step S1504 that there is no data having a module ID that matches the module ID 1002, a status indicative of abnormal termination of the present process is set in a step S1508.

In the present embodiment, whenever a predetermined process is carried out in the scanner engine 103, the printer engine 104 and/or the FAX board 105 to consume resources, the used resources totalizing module 504 is notified of a related module ID and the details of the used resources, and stores the data in a used resources totalizing table. The timing of notification and the type of resources are not limited to those exemplified in the present embodiment.

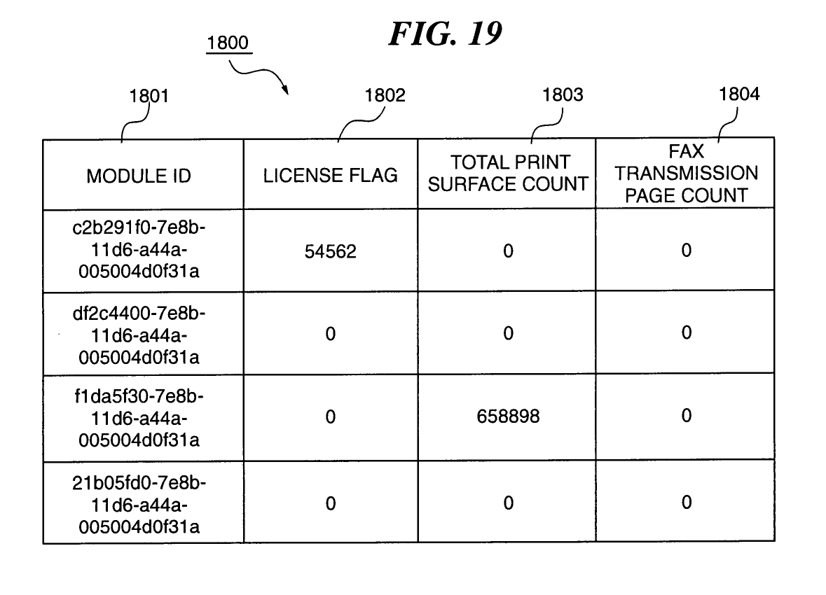

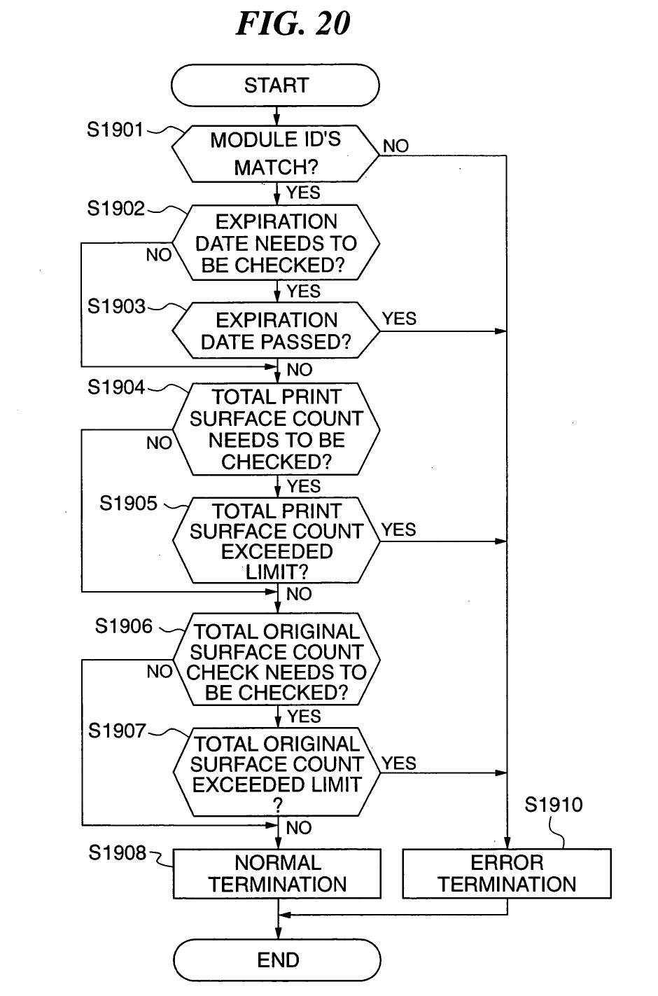

The notification of used resources and the used resources totalizing table will be described in more detail with reference to FIGS. 19 and 20. FIG. 19 is a diagram showing an example of the used resources totalizing table managed by the used resources totalizing module 504 appearing in FIG. 5, and FIG. 20 is a flowchart of a determination process executed by the license management module 503 appearing in FIG. 5.

The used resources totalizing module 504 manages the used resources totalizing table 1800 shown in FIG. 19. In the used resources totalizing table 1800, totalized data of a total print surface count 1802, a total original surface count 1803, and a FAX transmission page count 1804 are listed in association with each module ID 1801. In the present embodiment, only the respective ID's of the modules using the scanner engine 103, the printer engine 104, and the FAX board 105 are managed as module ID's 1801. The used resources to be totaled by the used resources totalizing module 504 are not limited to resources used by the scanner engine 103, the printer engine 104, and the FAX board 105, but the number of bytes of packets sent out onto the network 305 may be totaled.

The total print surface count 1802 represents the total number of print surfaces used by the printer engine 104. The total print surface count 1802 is counted up according to notification from the printer engine 104. The total original surface count 1803 represents the total number of original surfaces read by the scanner engine 103. The total original surface count 1803 is counted up according to notification from the scanner engine 103. The FAX transmission page count 1804 represents the total number of FAX transmission pages. The FAX transmission page count 1804 is counted up according to notification from the FAX board 105.

Each of all the program modules managed by the start program management data table 600 requests the license management module 503, before starting a process that uses resources, to determine whether the process can be started. At this time, the module ID of the program module on the requesting side is sent to the license management module 503.

More specifically, as shown in FIG. 20, first in a step S1901, it is determined in the license management module 503 whether or not any one of the module ID's 81 in the management information 80 managed by the license management module 503 matches the module ID sent from the program module on the requesting side. If there is a module ID that matches the sent module ID, it is determined in a step S1902 whether or not its expiration date needs to be checked. This determination is carried out by determining whether or not the most significant bit (0×8000) of the license flag 81 associated with the relevant module ID in the management information 80 is in the ON state. If the most significant bit (0×8000) of the license flag 81 associated with the relevant module ID is in the ON state, it is determined in a step S1903 whether or not the expiration date associated with the relevant module ID has passed. This determination is carried out by comparing the expiration date 83 associated with the relevant module ID in the management information 80 with time information (including year/month/day) of the clock 212, and determining, based on the result of the comparison, whether or not the expiration date of the corresponding program module having the module ID has passed. If the expiration date of the corresponding program module has not passed yet, the process proceeds to a step S1904.

On the other hand, if it is determined in the step S1902 that the expiration date need not be checked, the process skips over the step S1903 to the step S1904.

In the step S1904, it is determined whether or not the total print surface count needs to be checked. This determination is carried out by determining whether or not a predetermined bit (0×4000) of the license flag 82 associated with the relevant module ID 81 in the management information 80 is in the ON state. If the predetermined bit is in the ON state, it is determined in a step S1905 whether or not the total print surface count has exceeded its limit. This determination is carried out by comparing the total print surface count 84 associated with the relevant module ID in the management information 80 with the total print surface count 1802 associated with the relevant module ID in the used resources totalizing table 1800 held by the used resources totalizing module 504, and determining, based on the result of the comparison, whether or not the total print surface count has exceeded its limit. If the total print surface count has not exceeded its limit, the process proceeds to a step S1906.

On the other hand, if it is determined in the step S1904 that the total print surface count need not be checked, the process skips over the step S1905 to the step S1906.

In the step S1906, it is determined whether or not the total original surface count needs to be checked. This determination is carried out by determining whether or not a predetermined bit (0×2000) of the license flag 82 associated with the relevant module ID in the management information 80 is in the ON state. If the predetermined bit is in the ON state, it is determined that the total original surface count needs to be checked, and it is determined in a step S1907 whether or not the total original surface count has exceeded its limit. This determination is carried out by comparing the total original surface count 85 associated with the relevant module ID in the management information 80 with the total original surface count 1803 associated with the relevant module ID in the used resources totalizing table 1800 held by the used resources totalizing module 504, and determining, based on the result of the comparison, whether or not the total original surface count has not exceeded its limit. If the total original surface count has exceeded its limit, a status indicative of normal termination of the present process is set in a step S1908.

On the other hand, if it is determined in the step S1906 that the total original surface count need not be checked, the process skips over the step S1907 to the step S1908, wherein the status indicative of normal termination of the present process is set.

If it is determined in the step S1901 that there exists no module ID that matches the module ID sent from the program module on the requesting side, if it is determined in the step S1903 that the expiration date of the corresponding program module has passed, if it is determined in the step S1905 that the total print surface count has exceeded its limit, or if it is determined in the step S1907 that the total original surface count has exceeded its limit, a status indicative of abnormal termination of the present process is set in a step S1910.

Although in the present embodiment, whether or not an expiration date has passed and whether or not the used amount of resources has exceeded its limit are determined following the present flowchart before the start of each processing operation of the image forming apparatus 100, this is not limitative, but the above described process may be executed whenever the used resources totalizing table 1800 in the used resources totalizing module 504 is updated.

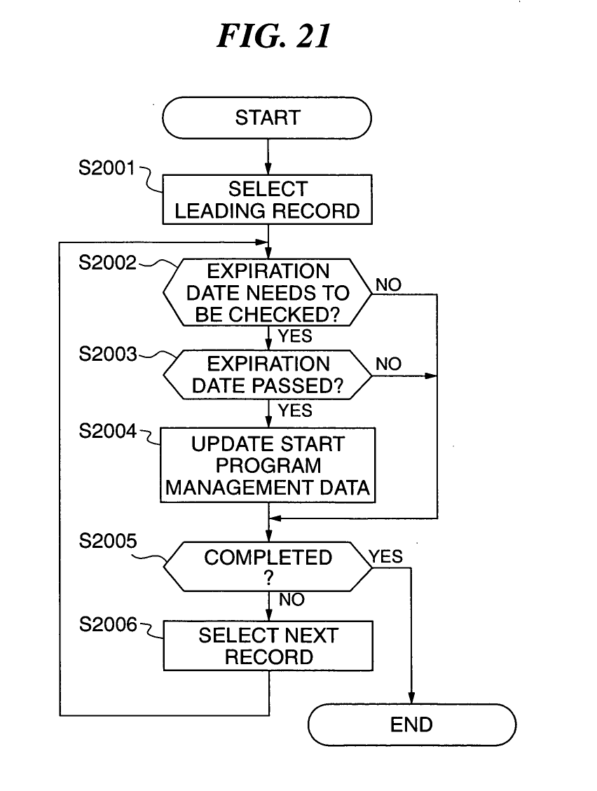

In the present embodiment, when the date of the clock 212 is updated, an expiration date check process is executed by the license management module 503. The expiration date check process will be described in detail with reference to FIG. 21. FIG. 21 is a flowchart of the expiration date check process.

In the expiration date check process, as shown in FIG. 21, first in a step S2001, a leading record of the management information 80 managed by the license management module 503 is selected, and in the following step S2002, it is determined whether or not an expiration date needs to be checked. This determination is carried out by determining whether or not the most significant bit (0×8000) of the license flag 82 associated with the module ID in the currently selected record in the management information 80 is in the ON state, and then determining, based on the result of the determination, whether or not the expiration date needs to be checked. If the most significant bit is in the ON state, it is determined in a step S2003 whether or not the expiration date has passed. This determination is carried out by comparing the expiration date 83 associated with the module ID in the currently selected record in the management information 80 with the time information of the clock 212, and determining, based on the result of the comparison, whether or not the expiration date has passed. As the time information, an expiration date represented by year/month/day is used. If the expiration date has passed, the data of the start program management data table 600 in the start program identification module 502 is updated in a step S2004. This update is carried out by changing the start flag 604 of data that matches the module ID 82 in the currently selected record is changed to a value indicative of a state not permitted to be started. Then, the process proceeds to a step S2005.

In the step S2005, it is determined whether or not processing for all the records has been completed. If the processing for all the records has not been completed, the subsequent record in the management information 80 is selected in a step S2006, followed by the process returning to the step S2002. On the other hand, if the processing for all the records has been completed, the present process is terminated.

If it is determined in the step S2002 that the expiration date need not be checked or if it is determined in the step S2003 that the expiration date has not passed, the steps S2003 and S2004 are skipped in the former case, and the step S2004 is skipped in the latter case, whereby the process proceeds to the step S2005, wherein it is determined whether or not processing for all the records has been completed. If the processing for all the records has not been completed, the subsequent record in the management information 80 is selected in the step S2006, followed by the process returning to the step S2002. On the other hand, if the processing for all the records has been completed, the present process is terminated.

It should be noted that although in the present embodiment, only “year/month/day” is checked, this is not limitative, but “hour” or “elapsed time from a predetermined time point” may be checked.

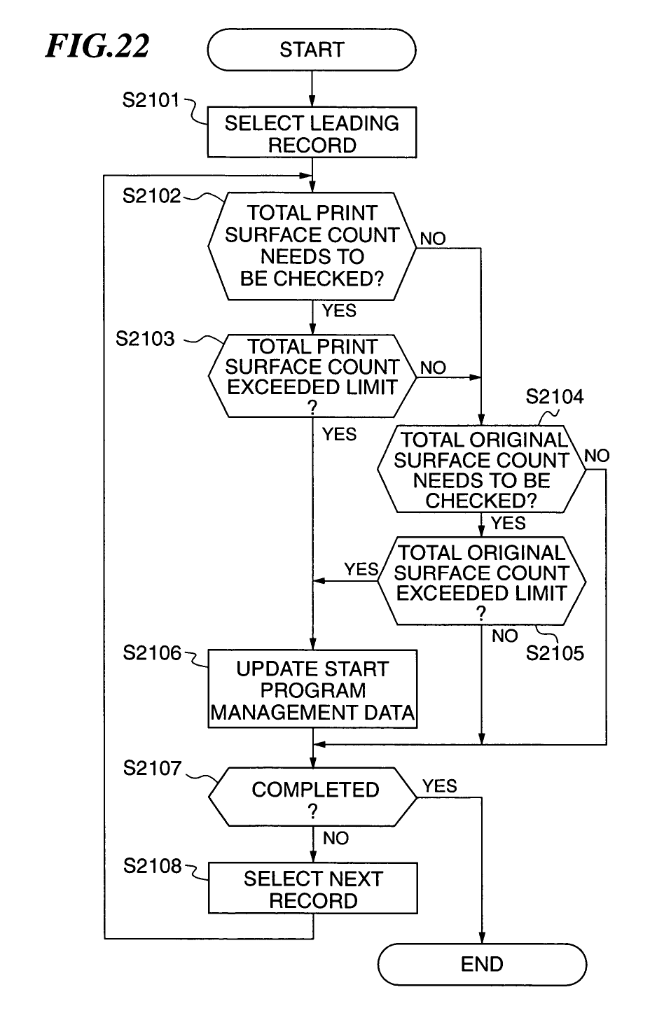

As described above, when the used resources totalizing table 1800 stored in the used resources totalizing module 504 is updated, the used resources check process is executed by the license management module 503. The used resources check process will be described in detail with reference to FIG. 22. FIG. 22 is a flowchart of the used resources check process.

In the used resources check process, as shown in FIG. 22, first, a leading record of the management information 80 stored in the license management module 503 is selected in a step S2101. Then, it is determined in a step S2102 whether or not the total print surface count needs to be checked. This determination is carried out by determining whether or not a predetermined bit (0×4000) of the license flag 82 associated with the module ID in the currently selected record in the management information 80 is in the ON state, and then determining, based on the result of the determination, whether or not the total print surface count needs to be checked. If it is determined in the step S2102 that the predetermined bit is in the ON state, it is determined in a step S2103 whether or not the total print surface count has exceeded its limit. This determination is carried out by comparing the total print surface count 84 in the currently selected record with the total print surface count 1802 associated with the corresponding module ID in the used resources totalizing table 1800 held by the used resources totalizing module 504, and determining, based on the result of the comparison, whether or not the total print surface count has exceeded its limit. If the total print surface count has exceeded its limit, the process proceeds to a step S2106.

If it is determined in the step S2102 that the total print surface count need not be checked, or if it is determined in the step S2103 that the total print surface count has not exceeded its limit, it is determined in a step S2104 whether or not the total original surface count needs to be checked. This determination is carried out by determining whether or not a predetermined bit (0×2000) of the license flag 82 associated with the module ID in the currently selected record is in the ON state, and then determining, based on the result of the determination, whether or not the total original surface count needs to be checked. If it is determined in the step S2104 that the predetermined bit is in the ON state, it is determined in a step S2105 whether or not the total original surface count has exceeded its limit. This determination is carried out by comparing the total original surface count 85 corresponding to the module ID in the currently selected record with the total original surface count 1803 associated with the corresponding module ID in the used resources totalizing table 1800 held by the used resources totalizing module 504, and determining, based on the result of the comparison, whether or not the total original surface count has exceeded its limit. If the total original surface count has exceeded its limit, the process proceeds to the step S2106.

In the step S2106, the data of the start program management data table 600 in the start program identification module 502 is updated. Then, it is determined in a step S2107 whether or not processing for all the records has been completed. If the processing for all the records has not been completed, the subsequent record in the start program management data table 600 is selected in a step S2108, followed by the process returning to the step S2102. On the other hand, if the processing for all the records has been completed, the present process is terminated.

If it is determined in the step S2104 that the total original surface count need not be checked, or if it is determined in the step S2105 that the total original surface count has not exceeded its limit, it is determined in the step S2107 whether or not the processing for all the records has been completed. If the processing for all the records has not been completed, the subsequent record in the start program management data table 600 is selected in the step S2108, followed by the process returning to the step S2102. On the other hand, if the processing for all the records has been completed, the present process is terminated.

Although in the present embodiment, only the total print surface count and the total original surface count are checked, this is not limitative, but other resources may be checked.

Thus, the present embodiment makes it possible to enable the program modules that realize optional functions, without extra costs, as well as to enhance security for the enabling of the optional functions.

Further, since an expiration date and a usage limit are set in license information, it is possible to prevent long-term illegal use of the optional functions.

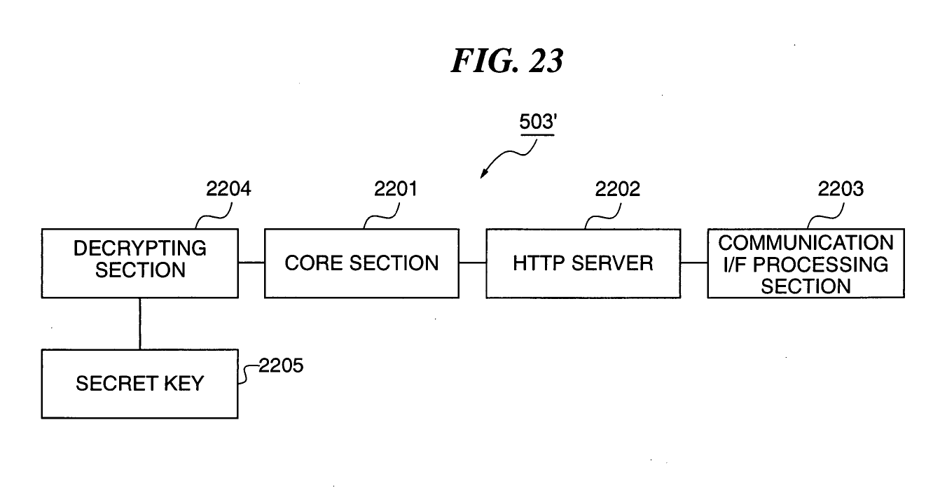

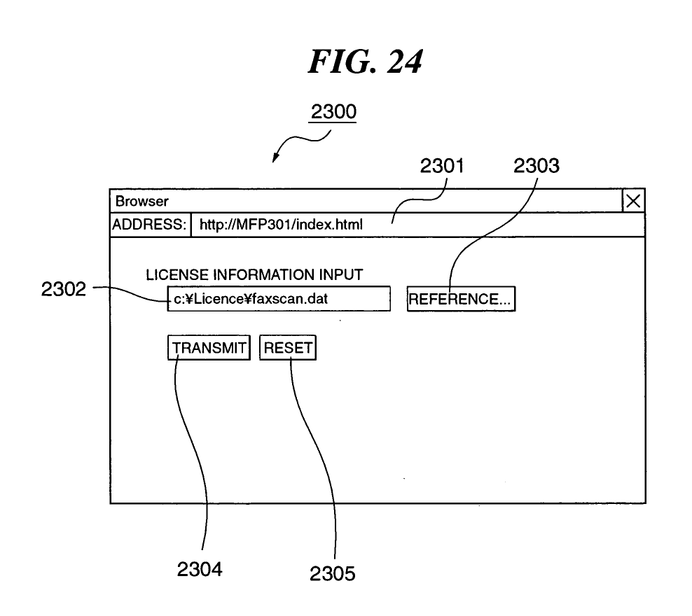

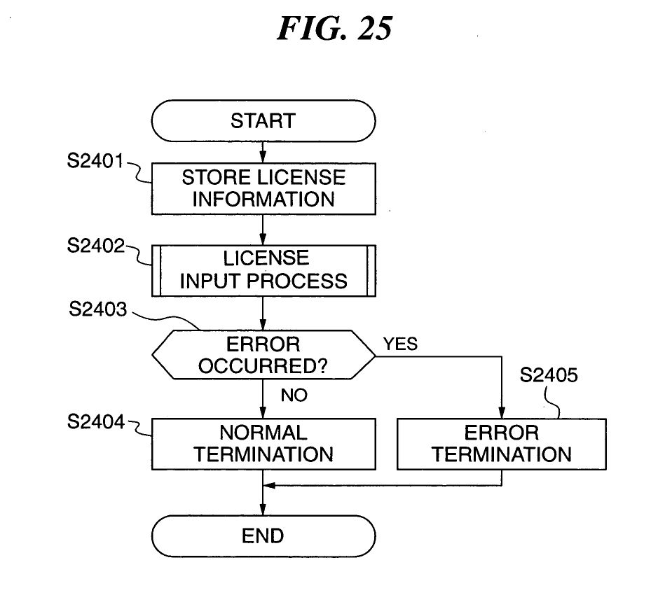

Next, a second embodiment of the present invention will be described with reference to FIGS. 23 to 25. FIG. 23 is a block diagram showing the software configuration of a license management module 503′ in an image forming apparatus according to the second embodiment, FIG. 24 is a diagram useful in explaining an example of a homepage displayed on a CRT 403 of a PC, and FIG. 25 is a flowchart showing part of a process executed by a core section 2201 of the license management module 503′ shown in FIG. 23.

As shown in FIG. 23, in the present embodiment, processes equivalent to those executed in the first embodiment are realized in response to instructions issued from application programs on the PC, not by operations from the operating section 106. More specifically, in the image forming apparatus 100 of the present embodiment, an HTTP server module is provided in the license management module 503′ for allowing communication from outside via the communication section 102, and license information 905 is transmitted to the image forming apparatus 100 from a general Web browser application provided in the PC, whereby the processes equivalent to those executed in the above described embodiment can be realized.

As shown in FIG. 23, the license management module 503′ in the second embodiment is comprised of a core section 2201 for executing a process represented by the flowchart shown in FIG. 25, described in detail hereinafter, an HTTP server 2202, a communication I/F processing section 2003, a decrypting section 2204, and a secret key 2205. The HTTP server 2202 enables access to the license management module 503′ by a browser application from a PC connected to the image forming apparatus 100 via the communication section 102. The server module for communicating with the PC is not limited to the HTTP server. The communication I/F processing section 2203 communicates with the communication section 102. The decrypting section 2204 executes a decryption process for decrypting the license information 905. The secret key 2205 is secret key information for use in decryption by the decrypting section 2204.

Although in the present embodiment, the public key and the secret key are used for encrypting and decrypting license information, this is not limitative. Further, it goes without saying that the secret key 2205 forms a pair with the public key 903.

In the present embodiment, the DISK 204 stores a homepage, and the homepage is transmitted to a corresponding PC by the HTTP server 2202. The PC receives the transmitted homepage and displays the same on the CRT 403, using the browser application operating on the PC. On the CRT 403 of the PC, the homepage 2300 illustrated in FIG. 24 is displayed, for example. The homepage 2300 includes an address display field 2301, a license information input field 2302, a file search screen display field 2303, a “transmission” button 2304 and a “reset” button 2305.

The address display field 2031 is for displaying a homepage address, and it is shown in FIG. 24 that the MFP301 (image forming apparatus 100) has been designated. The license information input field 2302 is for entering the data name and storage location of license information stored in a predetermined area of the DISK 407 in the PC. The file search screen display field 2303 displays a file search screen (not shown) for facilitating entry of the data name and storage location of license information. The “transmission” button 2304 is for sending the license information designated in the license information input field 2302 to the image forming apparatus 100, and in the present embodiment, the “transmission” button 2304 gives an instruction for reading the license information from the DISK 407 and transferring the same. The “reset” button 2305 is for clearing an entry in the license information input field 2302.

The layout of a screen displayed on the PC is not limited to that of the screen illustrated in FIG. 24.

The license information transmitted from the PC is received by the HTTP server 2202. When the license information has been received by the HTTP server, processing is started by the core section 2201 of the license management module 503′. More specifically, as shown in FIG. 25, first in a step S2401, the license information received from the PC by the HTTP server 2202 is stored in the RAM 202 or the DISK 204. Then, in a step S2402, the license input process is executed for actually reflecting the license information stored in the step S2401 on the image forming apparatus 100. This process is identical to the process executed by the license management module 503 of the first embodiment and represented by the flowchart in FIG. 16.

Then, it is determined in a step S2403 whether or not the process executed in the step S2402 has been normally terminated. If it has been normally terminated, a status indicative of normal termination of the process is set in a step S2404, whereas if it has been abnormally terminated, a status indicative of abnormal termination of the process is set in a step S2405.

Thus, the present embodiment makes it possible to enable the optional functions from the PC on the network 305 without a service person's in-field service at the site where the image forming apparatus 100 is installed, which contributes to further reduction of costs.

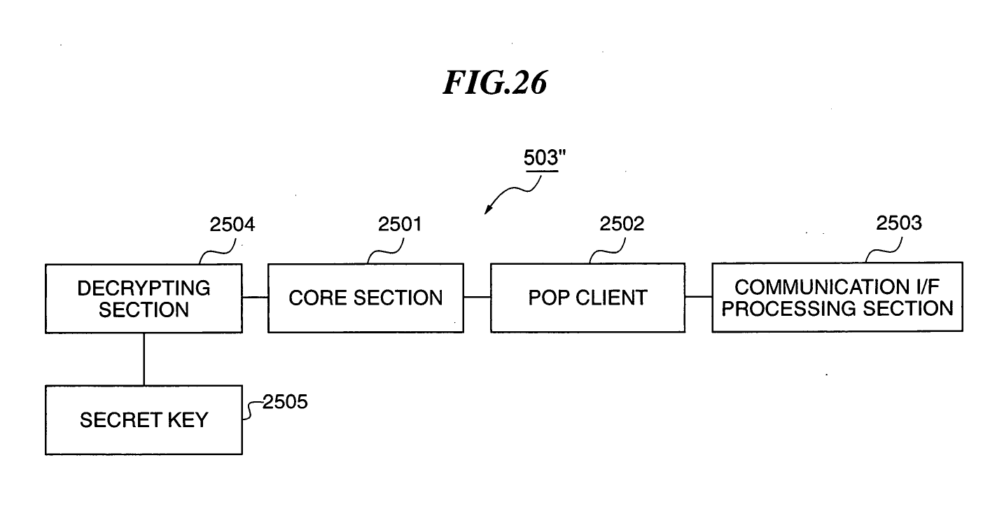

Next, a third embodiment of the present invention will be described with reference to FIG. 26. FIG. 26 is a block diagram showing the software configuration of a license management module 503″ of an image forming apparatus according to the third embodiment.

The present embodiment is distinguished from the second embodiment in which license information is inputted from the application program on the PC, in that the image forming apparatus 100 regularly checks whether or not the license information exists in the PC and when the license information exists, fetches the same from the PC to thereby realize processes equivalent to those executed in the above embodiments.

More specifically, the image forming apparatus 100 is provided with an E-mail client module, while the PC 303 is provided with a mail server. The client module regularly inquires of the mail server whether an E-mail has arrived, and if an E-mail has arrived, the client module receives the E-mail to obtain license information 905. In this case, the license information 905 is transmitted to the image forming apparatus 100, as a file attached to the E-mail.

As shown in FIG. 26, the license management module 503″ is comprised of a core section 2501, a POP client 2502, a communication I/F processing section 2503, a decrypting section 2504, and a secret key 2505.

The core section 2501 executes a process described hereinafter. The POP client 2502 enables the license management module 503″ to access the PC 303 provided with the mail server on the network 303, on which the POP client 2502 has an account, via the communication section 102, and receive E-mails. It is assumed that the setting of the account on the mail server PC 303, and the configuration of the POP client 2502 have been performed in advance in conventional methods. The communication I/F processing section 2503 communicates with the communication section 102. The decrypting section 2504 executes a decrypting process for decryption the license information 905. The secret key 2505 is secret key information for use in decryption by the decrypting section 2504.

Although in the present embodiment, the public key and the secret key are used for encrypting and decrypting license information, this is not limitative. Further, it goes without saying that the secret key 2505 forms a pair with the public key 903. Further, needles to say, the module for communicating with the PC and executing the process for receiving data is not limited to the POP client.

In the present embodiment, when the POP client 2502 receives license information attached to the E-mail, a predetermined process is executed by the core section 2501 of the license management module 503″. This predetermined process is substantially similar to the process executed in the second embodiment and represented by the flowchart in FIG. 25, and therefore only different points from the process in FIG. 25 will be described with reference to FIG. 25.

In the present embodiment, an E-mail having license information 905 attached thereto is transmitted from the mail server PC 303 to the image forming apparatus 100. Then, when the POP client 2502 receives the E-mail, the license information attached to the E-mail is taken out and stored in the RAM 202 or the DISK 204 (S2401). Thereafter, processing is carried out following the flowchart shown in FIG. 25.

Thus, the present embodiment makes it possible to enable the optional functions from a PC on the network 305 without a service person's in-field service at the site where the image forming apparatus 100 is installed, which contributes to further reduction of costs. In addition, it is possible to improve operability.

It goes without saying that the object of the present invention may also be accomplished by supplying a system or an apparatus with a storage medium (or a recording medium) in which a program code of software, which realizes the functions of each of the above described embodiments is stored, and causing a computer (or CPU or MPU) of the system or apparatus to read out and execute the program code stored in the storage medium.

In this case, the program code itself read from the storage medium realizes the functions of each of the above described embodiments, and hence the storage medium on which the program code is stored constitutes the present invention.

Further, it is to be understood that the functions of each of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of each of the above described embodiments may be accomplished by writing the program code read from the storage medium into a memory provided in an expansion board inserted into a computer or in an expansion unit connected to the computer and then causing a CPU or the like provided in the expansion board or the expansion unit to perform a part or all of the actual operations based on instructions of the program code.

Further, the above program has only to realize the functions of each of the above-mentioned embodiments on a computer, and the form of the program may be an object code, a program executed by an interpreter, or script data supplied to an OS.

The storage medium for supplying the program code may be of any type insofar as it can store the program code, and examples thereof include a RAM, a NV-RAM, a floppy (registered trademark) disk, an optical disk, a magnetic-optical disk, a CD-ROM, a CD-R, a CD-RW, a DVD (a DVD-ROM, a DVD-RAM, a DVD-RW, a DVD+RW), a magnetic tape, a nonvolatile memory card, and a ROM. Alternatively, the program code is supplied by downloading from another computer, a database, or the like, not shown, connected to the Internet, a commercial network, a local area network, or the like.

What is claimed is:

1. An image forming apparatus comprising:
a storage device that stores apparatus identification information for identifying the image forming apparatus, and a plurality of programs for realizing optional functions, respectively;
a program management device that holds start program identification information indicative of whether each of the plurality of programs has been set to a program to be executed at a start of the image forming apparatus, in association with each of the plurality of programs; and
a license management device that permits use of the plurality of programs on a program-by-program basis; and
wherein said license management device comprises:
a license information acquisition device that acquires license information including apparatus specifying information and program specifying information for specifying a program designated from an external device as a program to be executed at the start of the image forming apparatus;
a determination device that determines, by referring to the start program identification information held by said program management device, whether the program identified by the program identification information has been set to a program to be executed at the start of the image forming apparatus, when the apparatus specifying information included in the license information acquired by said license information acquisition device and the apparatus identification information stored in said storage device match, and the program specified by the program specifying information included in the license information is identical to any of the plurality of programs; and
a setting device that sets the program specified by the program specifying information to a program to be executed at the start of the image forming apparatus, when said determination device determines that the program specified by the program specifying information has not been set to a program to be executed at the start of the image forming apparatus.

2. An image forming apparatus as claimed in claim 1, further comprising an input device via which information can be inputted by operation of an operator, and an external storage device that holds the license information, and
wherein said license information acquisition device is responsive to input of predetermined instruction information via said input device by the operation of the operator, for reading and acquiring the license information from said external storage. device.

3. An image forming apparatus as claimed in claim 1, further comprising a communication device that communicates with an external device having a function of inputting the license information by operation of an operator, and a function of transmitting the license information inputted by the operation of the operator, and
wherein said license information acquisition device receives and acquires the license information transmitted from the external device, via said communication device.

4. An image forming apparatus as claimed in claim 1, further comprising a communication device that communicates with an external device capable of holding the license information, and an inquiry device that periodically inquires of the external device via said communication device whether the license information is held in the external device, and
wherein said license information acquisition device is responsive to a notification that the license information is held in the external device, given by the external device in response to the inquiry, for acquiring the license information from the external device via said communication device.

5. An image forming apparatus as claimed in claim 1, further comprising a clock device that outputs time information, and
wherein the license information includes an expiration date of the program specified thereby, and
wherein said license management device comprises:
a license information holding device that holds the license information associated with each of programs set to a program to be executed at the start of the image forming apparatus;
an expiration date determining device that compares the expiration date included in the license information associated with each of the programs set to a program to be executed at the start of the image forming apparatus with the time information outputted from said clock device, to thereby determine whether the expiration date has passed; and
a limiting device that limits execution of each of the programs set to a program to be executed at the start of the image forming apparatus, based on a result of the determination by said expiration date determining device.

6. An image forming apparatus as claimed in claim 1, further comprising a totalizing device that totalizes amounts of usage of apparatus resources used by operation of the programs on a program-by-program. basis, and
wherein the license information includes an upper limit of an amount of usage of resources usable by each program specified by the license information, and
wherein said license management device comprises:
a license information holding device that holds the license information associated with each of programs set to a program to be executed at the start of the image forming apparatus;
a usage determining device that determines whether the amount of usage of the apparatus resources used by each of the programs set to a program to be executed at the start of the image forming apparatus has reached the upper limit thereof; and
a limiting device that limits execution of each of the programs set to a program to be executed at the start of the image forming apparatus, based on a result of the determination by said usage determining device.

7. An image forming apparatus as claimed in claim 1, wherein the license information comprises encrypted information, and said license management device comprises a decrypting device that decrypts the license information.

8. A method of controlling an image forming apparatus including a storage device that stores apparatus identification information for identifying the image forming apparatus, and a plurality of programs for realizing optional functions, respectively, and a program management device that holds start program identification information indicative of whether each of the plurality of programs has been set to a program to be executed at a start of the image forming apparatus, in association with each of the plurality of programs,
the method comprising:
a license information acquisition step of acquiring license information including apparatus specifying information and program specifying information for specifying a program designated from an external device as a program to be executed at the start of the image forming apparatus;
a determination step of determining, by referring to the start program identification information held by said program management device, whether the program identified by the program identification information has been set to a program to be executed at the start of the image forming apparatus, when the apparatus specifying information included in the license information acquired in said license information acquisition step and the apparatus identification information stored in said storage device match, and the program specified by the program specifying information included in the license information is identical to any of the plurality of programs; and
a setting step of setting the program specified by the program specifying information to a program to be executed at the start of the image forming apparatus, when it is determined in said determination step that the program specified by the program specifying information has not been set to a program to be executed at the start of the image forming apparatus.

9. A program for controlling an image forming apparatus including a storage device that stores apparatus identification information for identifying the image forming apparatus, and a plurality of programs for realizing optional functions, respectively, and a program management device that holds start program identification information indicative of whether each of the plurality of programs has been set to a program to be executed at a start of the image forming apparatus, in association with each of the plurality of programs,
the program comprising:
a license information acquisition module for acquiring license information including apparatus specifying information and program specifying information for specifying a program designated from an external device as a program to be executed at the start of the image forming apparatus;
a determination module for determining, by referring to the start program identification information held by said program management device, whether the program identified by the program identification information has been set to a program to be executed at the start of the image forming apparatus, when the apparatus specifying information included in the license information acquired by said license information acquisition module and the apparatus identification information stored in said storage device match, and the program specified by the program specifying information included in the license information is identical to any of the plurality of programs; and
a setting module for setting the program specified by the program specifying information to a program to be executed at the start of the image forming apparatus, when it is determined by said determination module that the program specified by the program specifying information has not been set to a program to be executed at the start of the image forming apparatus.

10. A computer-readable storage medium storing a program for controlling an image forming apparatus including a storage device that stores apparatus identification information for identifying the image forming apparatus, and a plurality of programs for realizing optional functions, respectively, and a program management device that holds start program identification information indicative of whether each of the plurality of programs has been set to a program to be executed at a start of the image forming apparatus, in association with each of the plurality of programs,
the program comprising:
a license information acquisition module for acquiring license information including apparatus specifying information and program specifying information for specifying a program designated from an external device as a program to be executed at the start of the image forming apparatus;
a determination module for determining, by referring to the start program identification information held by said program management device, whether the program identified by the program identification information has been set to a program to be executed at the start of the image forming apparatus, when the apparatus specifying information included in the license information acquired by said license information acquisition module and the apparatus identification information stored in said storage device match, and the program specified by the program specifying information included in the license information is identical to any of the plurality of programs; and
a setting module for setting the program specified by the program specifying information to a program to be executed at the start of the image forming apparatus, when it is determined by said determination module that the program specified by the program specifying information has not been set to a program to be executed at the start of the image forming apparatus.
